(19) United States
(12) Patent Application Publication
(10) Pub. No.: US 2025/0369070 A1
(43) Pub. Date: Dec. 4, 2025

(54) METHOD OF MANUFACTURING ALUMINIUM DEOX, ALUMINIUM POWDER, AND ZINC OXIDE IN A SINGLE BATCH PROCESS

(71) Applicant: BN Industries, Daman and Diu (IN)

(72) Inventor: Ashwini Brahmanand SINGHAL, Mumbai (IN)

(21) Appl. No.: 18/875,122

(22) PCT Filed: Jun. 12, 2023
(86) PCT No.: PCT/IN2023/050552

§ 371 Date: Dec. 14, 2024

(30) Foreign Application Priority Data
Jun. 17, 2022 (IN) 202221034669

(51) Int. Cl. C22B 19/34; B22F 9/08; C01G 9/03; C22B 9/00; C22B 9/10; C22B 19/12

(52) U.S. Cl. CPC C22B 19/34; B22F 9/082; C01G 9/03; C22B 9/003; C22B 9/10; C22B 19/12; B22F 2301/052; B22F 2998/10

(57) ABSTRACT

The present disclosure relates to a method for manufacturing aluminium deox, aluminium powder, and zinc oxide in a single batch process. The method comprises feeding galvalume dross into induction furnace to melt the galvalume dross. The method includes extracting zinc oxide powder, aluminium deox and aluminium powder from the molten galvalume dross.

### TECHNICAL FIELD

The present disclosure relates to field of treating galvalume dross that is formed during process of galvanizing steel. Particularly, but not exclusively, the present disclosure is directed towards a method of manufacturing aluminium deox, aluminium powder, and zinc oxide from the galvalume dross in a single batch process.

### BACKGROUND

Galvalume dross is a by-product of process of galvanizing steel. Steel article is galvanized to improve corrosion resistance of steel. Galvanizing is extensively used to produce coating on steel, wherein the process of galvanizing is conducted by immersion of the steel article in molten zinc and aluminium bath. In the process of galvanization, fresh zinc and aluminium is added in a regular interval as a significant amount of zinc and aluminium is lost in the form of galvalume dross. Galvalume dross is a combination of free zinc and Zn—Fe—Al intermetallic compounds which are formed by multiple reactions among zinc, aluminium and dissolved iron from the immersed steel article. The galvalume dross is a valuable by-product because it contains high levels of zinc and aluminium. However, zinc and aluminium resources are often wasted due to lack of techniques and initiatives of extracting zinc and aluminum from galvalume dross. Also, long term storage of galvalume dross creates long term environmental issue.

Conventionally, a plurality of techniques have been investigated to recover zinc and aluminium from the galvalume dross in different extraction processes, wherein such techniques include but not limited to distillation, electro refining, leaching, super gravity technology etc. However, such conventional techniques extracts each of zinc, aluminium, silicon, iron etc. from raw material like galvalume dross by using separate independent process for each type of extraction. Therefore, manufacturers do produce Aluminium Deox/Powder and Zinc Oxide; but they make it in two independent processes, in two different batches and from two different raw materials. They produce Aluminium finished product from Aluminium bearing raw material and similarly Zinc finished product from Zinc bearing raw material independently and having no relation with each other. Such conventional techniques consume a huge of time and cost towards infrastructure of extracting aluminium powder, zinc oxide etc. Therefore, there is a need for a process of making Aluminium Deox/Powder and Zinc Oxide from one raw material i.e. Galvalume Dross in single batch process.

The present disclosure is directed to overcome one or more limitations stated above, and any other limitation associated with the prior arts.

### SUMMARY

The present disclosure provides a method for manufacturing aluminium deox, aluminium powder, and zinc oxide from galvalume dross in a single batch process. The method comprises feeding galvalume dross into an induction furnace to melt the galvalume dross, wherein the galvalume dross is received as a by-product. The received galvalume dross is categorized into one of top grade galvalume dross, bottom grade galvalume dross and galvalume dross of defined sizes, wherein the top grade galvalume dross and the bottom grade galvalume dross are categorized based on iron content of the received galvalume dross. The method further comprises the steps of transferring the molten galvalume dross into a Silicon Carbide Crucible furnace for heating the molten galvalume dross to a predefined temperature, wherein upon heating the molten galvalume dross, zinc vapor evaporates from top of the molten galvalume dross. The method includes collecting the zinc vapor into an oxidation chamber to produce zinc oxide powder and adding pure aluminum to residual molten metal based upon determination of quality testing of the molten metal, wherein the residual molten metal is residual content upon having the zinc vapor evaporated from the molten galvalume dross. The method further includes casting the molten metal by casting machine to produce aluminum deox or aluminum powder.

The foregoing summary in illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a flowchart showing a method of manufacturing aluminium deox, aluminium powder, and zinc oxide from galvalume dross in a single batch process, in accordance with an embodiment of the present disclosure;

FIG. 2A illustrates a flowchart showing steps of processing received galvalume dross, in accordance with an embodiment of the present disclosure;

FIG. 2B illustrates a flowchart showing steps of producing zinc oxide powder from the received galvalume dross, in accordance with an embodiment of the present disclosure;

FIG. 3A illustrates a flowchart showing steps of processing residual molten metal after extraction of zinc vapor, in accordance with an embodiment of the present disclosure; and

FIG. 3B illustrates a flowchart showing steps of producing aluminium powder from the residual molten metal, in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

Embodiments of the present disclosure provide a method for manufacturing aluminium deox, aluminium powder, and zinc oxide from galvalume dross in a single batch process. The method comprises feeding galvalume dross into an induction furnace to melt the galvalume dross, wherein the galvalume dross is received as a by-product. The received galvalume dross is categorized into one of top grade galvalume dross, bottom grade galvalume dross and galvalume dross of defined sizes before feeding into the induction furnace, wherein the top grade galvalume dross and the bottom grade galvalume dross are categorized based on iron content of the received galvalume dross. The method further comprises the steps of transferring the molten galvalume dross into a Silicon Carbide Crucible furnace for heating the molten galvalume dross to a predefined temperature, wherein upon heating the molten galvalume dross, zinc vapor evaporates from top of the molten galvalume dross. The method includes collecting the zinc vapor into an oxidation chamber to produce zinc oxide powder and adding pure aluminum to residual molten metal based upon determination of quality testing of the molten metal, wherein the residual molten metal is residual content upon having the zinc vapor evaporated from the molten galvalume dross. The method further includes casting the molten metal by casting machine to produce aluminum deox or aluminum powder.

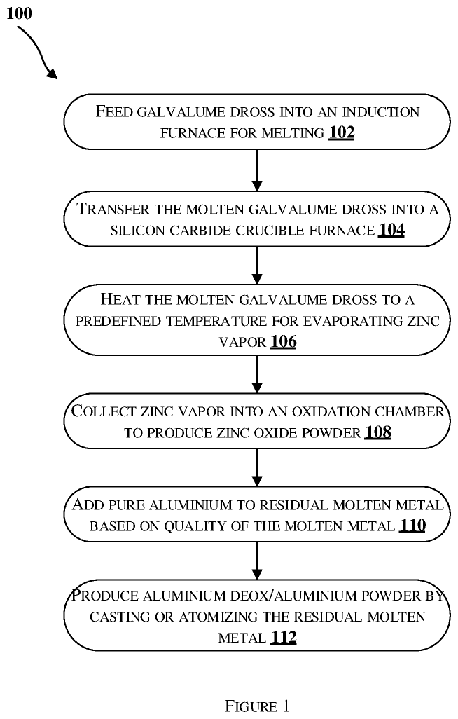

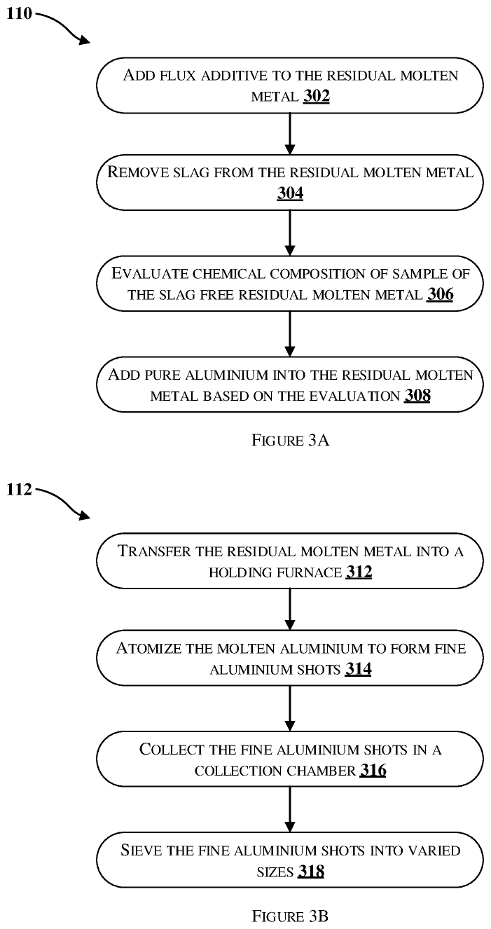

The following paragraphs describe the present disclosure with reference to FIGS. 1 and 3B. In the figures, FIG. 1 is an exemplary method of the present disclosure and illustrates various steps of the method (100) for manufacturing aluminium deox, aluminium powder and zinc oxide in a single batch process. The method (100) enables manufacturers to produce aluminium deox, aluminium powder and zinc oxide from the galvalume dross that is a waste by-product of process of galvanizing metal article in a single batch process. The method (100) therefore eliminates the requirement of using two independent processes, two different batches and two different raw materials for producing aluminium deox/powder and zinc oxide from the galvalume dross. In one embodiment, the method (100) according to present disclosure aids in bifurcating the galvalume dross into secondary aluminium and zinc independently in a single batch process. Thus, the method (100) enables the manufacturer in recycling the galvalume dross in the most efficient technique. The method (100) further requires only one set of machinery to produce both secondary Aluminium and Zinc Oxide. Therefore, the present invention saves cost, time, fuel, energy, ground space and manual effort as compared to the traditional methods of producing secondary aluminium and zinc.

However, it is understood by a person skilled in the art that the size and configuration of the required set of machinery for accomplishing the method (100) may be variable in accordance with the requirement of the different types of installation environment. Any such variation/modification shall be construed to be within the scope of the present disclosure.

As illustrated in FIG. 1, the method (100) comprises one or more blocks to be performed to manufacture aluminium deox, aluminium powder and zinc oxide in a single batch process. The order in which the method (100) is described is not intended to be construed as a limitation, and any number of the described method blocks can be combined in any order to implement the method. Additionally, individual blocks may be deleted from the methods without departing from the spirit and scope of the subject matter described herein.

At block (102), galvalume dross is fed into an induction furnace for melting. In one embodiment, the galvalume dross is received as a by-product and the galvalume dross is available in shape of big blocks, wherein weight of each block is in a range from 50 kg to 1,500 kg depending upon the dross handling practice at source i.e., mill that generates such dross. Upon receipt of the galvalume dross, the galvalume dross is categorized into one of top grade galvalume dross, bottom grade galvalume dross and galvalume dross of defined sizes. The top grade galvalume dross and the bottom grade galvalume dross are categorized based on iron content of the received galvalume dross. In an example, the top grade galvalume dross can comprise chemical composition of aluminium, zinc, iron, silicon, and copper in a proportion as mentioned in Table 1.

TABLE 1

| | Aluminium | Zinc | Iron | Silicon | Copper |
|---|---|---|---|---|---|
| Component | (Al) | (Zn) | (Fe) | (Si) | (Cu) |
| Min (%) | 55.0 | 35.0 | 0.5 | 2.0 | 0.02 |
| Max (%) | 59.0 | 41.0 | 3.0 | 3.5 | 0.15 |

In another example, the bottom grade galvalume dross can comprise chemical composition of aluminium, zinc, iron, silicon, and copper in a proportion as mentioned in Table 2.

TABLE 2

| | Aluminium | Zinc | Iron | Silicon | Copper |
|---|---|---|---|---|---|
| Component | (Al) | (Zn) | (Fe) | (Si) | (Cu) |
| Min (%) | 54.0 | 27.0 | 6.0 | 2.5 | 0.10 |
| Max (%) | 61.0 | 32.0 | 11.0 | 5.0 | 0.90 |

Further, the galvalume dross is fed into the induction furnace for melting. In one embodiment, in case of top grade galvalume dross, the galvalume dross is directly fed into the induction furnace for melting. In case of bottom grade galvalume dross, the galvalume dross is cut into smaller pieces having dimensions of each piece less than equal to 21 inches, wherein such small pieces of the bottom grade galvalume dross are directly transferred to the Silicon Carbide Crucible furnace for processing. The top grade galvalume dross is put into the induction furnace by using over-head cranes, wherein crane of suitable capacity is used for safely transferring the top grade galvalume into the induction furnace. A set of iron hooks attached to the blocks of the top grade galvalume dross are taken out as early as possible to prevent any iron built up in the metal bath.

The induction furnace is an electrical furnace in which the heat is applied by induction heating of the galvalume dross. Induction furnace capacities range from less than one kilogram to one hundred tons, and are used to melt iron and steel, copper, aluminum, and precious metals. The induction furnace provides a clean, energy-efficient and well-controlled melting process compared to most other means of metal melting. The induction furnace works with the principle of induction heating, wherein conductive materials are heated in non-contact fashion. Therefore, the induction furnace eliminates the requirement of burning fuel or other external heat source.

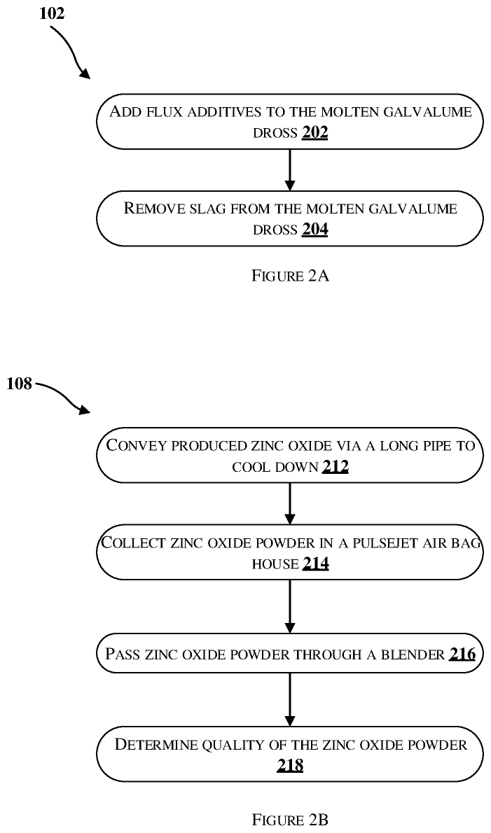

Therefore, the received galvalume dross is melted within the induction furnace. Further, the process of melting the received galvalume dross is performed via steps as illustrated in FIG. 2A.

At block (202), flux additives are added to the molten galvalume dross. In one embodiment, flux Additives in a mixture of cover flux (1.5% of induction furnace batch weight) and sodium cryolite (0.5% of induction batch weight) are added to the bath i.e., the molten galvalume dross. Consequently, top surface of the molten galvalume dross is covered with flux to minimize oxidation of metal.

At block (204), slag is removed from the molten galvalume dross. In one embodiment, the slag occurs when the galvalume dross is melt and is a complex solution of silicates and oxides that solidifies upon cooling. The slag is removed from the molten galvalume dross to assist in the removal of impurities and protect the induction furnace refractory lining from excessive wear.

Upon removal of slag from the top of the molten galvalume dross, the slag free molten galvalume dross is further processed as illustrated in FIG. 1.

At block (104), the slag free molten galvalume dross is transferred into a Silicon Carbide Crucible furnace. In one embodiment, the slag free molten galvalume dross is transferred into the Silicon Carbide Crucible furnace for processing the molten galvalume dross in high temperature. The Silicon Carbide Crucible furnace is designed to deliver precision high-temperature uniformity and for efficient indirect heating of non-ferrous metals. Silicon carbide is a ceramic material with relatively high electrical conductivity when compared to other ceramics.

In the process of transferring the slag free molten galvalume dross into the Silicon Carbide Crucible furnace, the induction furnace is titled by 90 degree, wherein the molten galvalume dross flows through a launder and is filled into a Ladle. Further, the molten galvalume dross is transferred from the Ladle into the Silicon Carbide Crucible furnace. In case of bottom galvalume dross, solid bottom galvalume dross is directly inserted into the Silicon Carbide Crucible furnace for melting.

Thus, the top galvalume dross is first added to the induction furnace for melting and thereafter the molten metal of galvalume dross is transferred to Silicon Carbide Crucible furnace. Induction furnace is bigger furnace in size compared to the Silicon Carbide Crucible furnace. Therefore, the induction furnace can accommodate larger size of galvalume dross pieces and can melt the larger size galvalume dross pieces without cutting into pieces with reduced size. Also, the use of induction furnace incurs lower fuel cost compared to that of Silicon Carbide Crucible furnace and also saves time of Silicon Carbide Crucible furnace thereby increasing production of zinc and secondary aluminium. However, the top galvalume dross can also be directly melted in Silicon Carbide Crucible furnace if required in instances like induction furnace is pre-occupied with other work in progress material or under maintenance or higher volume of galvalume dross is needed by the multiple Silicon Carbide Crucible furnaces than what induction furnace can transfer.

At block (106), the molten galvalume dross is hated up to a predefined temperature for evaporating zinc vapor. In one embodiment, the molten galvalume dross is further heated in the Silicon Carbide Crucible Furnace. The molten galvalume dross is heated up to the predefined temperature range of 1300° C. to 1400° C. to boil metal of the molten galvalume dross. Upon heating the molten galvalume dross, zinc vapor evaporates from top of the molten galvalume dross. Zinc is converted to gaseous form because zinc has boiling point at 907° C., wherein the other metals of the galvalume dross i.e., Aluminium (Al), Silicon (Si), Iron (Fe) and Copper (Cu) have the boiling point at 2470° C., 2355° C., 2862° C. and 2560° C. respectively. Since Zinc's boiling point is lower than that of other metal elements present in Galvalume Dross i.e. Al, Si, Fe and Cu, only Zinc evaporates to form zinc vapor and other metals remain in the molten form in the crucible.

At block (108), the zinc vapor is collected into an oxidation chamber to produce zinc oxide powder. In one embodiment, the zinc vapor is collected in an oxidation chamber, wherein the zinc vapor reacts with oxygen from air and produce zinc oxide vapor. Further, the process of collecting the zinc oxide vapor is performed via steps as illustrated in FIG. 2B.

At block (212), the zinc oxide vapor is conveyed via a long pipe to cool down. In one embodiment, the zinc oxide vapor is conveyed via a four hundred feet long pipe to cool down to form fine white solid powder i.e., zinc oxide powder.

At block (214), the zinc oxide powder is collected in a pulsejet air bag house. In one embodiment, the zinc oxide in solid powder form is emptied from the pulsejet air baghouse. The pulsejet air baghouse or pulse jet dust collector, is a self-cleaning dry filtration system. The pulsejet dust collector cleaning system removes particulate matter and dust from the surface of internal filter media with bursts of compressed air. The pulse jet style of dust collector is used due to its ease of operation, low energy usage, and minimal maintenance requirements.

At block (216), zinc oxide powder is passed through a blender. In one embodiment, upon completion of pulsejet filtration of the zinc oxide powder, the zinc oxide powder is passed through a blender for raising bulk density of the zinc oxide powder.

At block (218), quality of the zinc oxide powder is determined. In one embodiment, the quality of zinc oxide is periodically checked for multiple times in the same heat by respective quality assurance team in laboratory by following standard quality procedure. After determining the quality, zinc oxide is weighed and packed into 25 kg HDPE bags.

In an example, the zinc oxide produced from the galvalume dross is evaluated to have purity in range illustrated in Table 3.

TABLE 3

| Element | ZnO Purity |
|---|---|
| Min (%) | 85.0 |
| Max (%) | 99.3 |

Therefore, Zinc Oxide white seal grade is produced as a finished product having application in the manufacturing of Ceramics, Rubber and Paints.

Upon zinc vaporization from the top of the molten galvalume dross is complete, the residual molten metal is further processed as illustrated in FIG. 1.

At block (110), pure aluminium is added to the residual molten metal based on quality of the molten metal. In one embodiment, the process of adding pure aluminum to the residual molten metal is performed via steps as illustrated in FIG. 3A.

At block (302), flux additives are added to the residual molten metal. In one embodiment, upon completion of zinc vaporization, flux additive pink cover flux is added to the residual molten metal and mixture is stirred. The residual molten metal is the content residue upon having the zinc vapor evaporated from the molten galvalume dross, wherein the residue content is the secondary aluminium containing small volume presence of other elements Si, Fe and Cu.

Conventionally, the secondary aluminum is made from recycled aluminum scrap that is come from all sorts of aluminum products and profiles, such as aluminum turnings, aluminum sheets, aluminum shreds, aluminum radiators, cast aluminum, extrusions, painted sidings, aluminum dross, and more. Generally, secondary aluminum has a higher tolerance for alloying elements, such as iron, magnesium, and silicon.

At block (304), slag is removed from the residual molten metal. In one embodiment, the slag is removed from the residual molten metal by using manual effort or power tools.

At block (306), chemical composition of the slag free residual molten metal is evaluated. In one embodiment, a sample of the residual molten metal is evaluated for its chemical composition by quality assurance team through lab quality equipment such as Optical Emission Spectrophotometer (OES).

The OES is used to know instant chemical composition of finished goods and raw material. The OES is a well trusted and widely used analytical instrument that is used to determine the elemental composition of a broad range of metals. The type of samples which are tested using OES include samples from the melt in primary and secondary metal production, and in the metals processing industries, tubes, bolts, rods, wires, plates and many more. OES can analyze a wide range of elements from hydrogen to uranium in solid metal examples covering a wide concentration range, giving very high accuracy, high precision and low detection limits.

The quality test aids in determining whether the chemical composition of the residual molten metal is matching with customer requirement or not.

At block (308), pure aluminium is added to the residual molten metal based on the evaluation. In one embodiment, upon determining mismatch with customer requirement, pure aluminum is then added in into the Silicon Carbide Crucible Furnace to achieve the desired composition of the residual molten metal. A sample of the residual molten metal is again drawn and then evaluated in the OES to verify that the chemistry of the metal melt is as per customer requirement. In case the quality received is not as desired, pure 99.5% aluminium ingots or aluminium scrap is added to the residual molten metal and the mixture is homogenized by stirring. Upon adding the pure aluminum, a sample of the residual molten metal is again drawn and chemistry is checked by using the OES.

Thus, the quality of the secondary aluminium is enhanced by adding pure aluminium to the residual molten metal.

Upon completion of the quality test and finalizing quality of the desired secondary aluminium, the residual molten metal is further processed as illustrated in FIG. 1.

At block (112), aluminium deox/aluminium powder is produced by casting or atomizing the residual molten metal.

In one embodiment, upon finalizing quality of the secondary aluminium, the residual molten metal is casted into moulds of desired shape to obtain the aluminum deox of desired shape. In case shape such as shots is to be made, then molten metal is transferred to shot casting machine such as homemade chakari where the molten metal is passed through holes of a tray which on cooling solidify to form droplets called shots or granules. In case of aluminium ingot, cube or hemisphere, the molten metal is poured onto customized moulds having the respective shape and size as per customer requirement. Further, the aluminium deox is packed into 50 kg HDPE woven bags or 1 MT Jumbo HDPE bags as per customer requirement.

In an example, the aluminium deox produced from top galvalume dross (having lower iron content) is evaluated to have chemical compositions in proportion illustrated in Table 4.

TABLE 4

| Element | Aluminium (Al) | Zinc (Zn) | Silicon (Si) | Iron (Fe) |
|---|---|---|---|---|
| Min (%) | 87.0 | 1.5 | 2.0 | 2.0 |
| Max (%) | 93.0 | 4.5 | 4.0 | 5.5 |

In an example, the aluminium deox produced from bottom galvalume dross (having higher iron content) is evaluated to have chemical compositions in proportion illustrated in Table 5.

TABLE 5

| Element | Aluminium (Al) | Zinc (Zn) | Silicon (Si) | Iron (Fe) |
|---|---|---|---|---|
| Min (%) | 78.0 | 1.5 | 2.0 | 7.0 |
| Max (%) | 83.0 | 4.5 | 5.2 | 15.0 |

The aluminium deox, as manufactured from the galvalume dross, is a de-oxidant which has application in de-oxidation of molten steel, that improves the quality of steel. Molten steel contains dissolved oxygen which is important to be removed at stage of melting, otherwise the solid steel contains porosity which in turn reduces tensile strength of the steel.

In another embodiment, the residual molten metal is processed to produce aluminum powder. The process of producing aluminium powder from the residual molten metal is performed via steps as illustrated in FIG. 3B.

At block (312), the residual molten metal is transferred into a holding furnace. In one embodiment, the holding furnace is used to further process the molten metal. The holding furnace is a heated reservoir to hold the molten metal preparatory to casting.

At block (314), the molten aluminium is atomized to form fine aluminum shots. In one embodiment, a jet of high-pressure air is used within the holding furnace to atomize the molten metal into fine molten particles or shots which on ambient cooling forms solid powder i.e., aluminium powder.

At block (316), the fine aluminium shots is collected in collection chamber. In one embodiment, the fine aluminium shots are collected in the collection chamber attached to the holding furnace. In an example, atomization is done by 10 kg air pressure from the nozzle bifurcating the molten metal after passing it through a ceramic tablet having 4.5 mm hole. The hot air from chamber is sucked by a 3 HP fan.

At block (318), the fine aluminium shots are sieved into varied sizes. In one embodiment, the aluminium powder in the form of fine aluminium shots is sieved into varied sizes and packed in 25 Kg HDPE bags. The finer variant of aluminum powder is collected in the cyclone, which is present between the fan and the collection chamber. Aluminium fine shots that is used for different applications.

In an example, the aluminium powder produced from the galvalume dross is evaluated to have chemical compositions in proportion illustrated in Table 6.

TABLE 6

| Element | Aluminium (Al) | Zinc (Zn) | Silicon (Si) | Iron (Fe) |
|---|---|---|---|---|
| Min (%) | 89.0 | 1.0 | 1.0 | 1.0 |
| Max (%) | 95.0 | 3.8 | 3.3 | 4.0 |

The aluminium powder formed through atomization is used in different applications such as manufacture of ferro alloys such as ferro manganese, ferro chrome and more. During preparation of ferro alloy, aluminium powder is added for thermite reaction to take place, wherein the thermite reaction is an exothermic reaction that produces extreme heat required to produce the ferro alloy. The aluminium powder may also be used in the firecracker industry for the same purpose. For the aforementioned applications, the aluminium powder size varies in a range of −10 mesh to +100 mesh.

Further, finer aluminium powder of mesh size i.e., −200 mesh is used in the manufacture of aluminium phosphide (ALPHOS) which is a fumigant. Aluminium powder of mesh size −300 mesh is used to produce AAC Blocks (Aerated Auto Conclave Blocks).

In an experiment, information related each process cycle is recorded. In an exemplary illustration, each process cycle of Silicon Carbide Crucible furnace i.e., a batch is called a heat and is allocated a heat number. Each heat has weight of 800 kg as input in molten (in case of top galvalume dross) or solid form (in case of bottom galvalume dross). Production process of each heat is made up of 4 stages such as charging, oxidation, sampling and casting. During charging stage, temperature of the input is increased to boil the same at 1400° C., wherein the charging process takes time in ranges from 1 hour when Silicon Carbide Crucible furnace is fed with molten metal from induction furnace to 4 hours when solid dross is directly melted. Further, the oxidation process takes approximately 6 hours, wherein the zinc vapor form react with oxygen to form zinc oxide. Furthermore, sampling process takes approximately 0.5 hour and casting process takes around 1.5 hour. Therefore, the total time per heat is around 12 hours, wherein such time may be reduced to approximately 9 hours when the molten metal is directly transferred to Silicon Carbide Crucible furnace. Also when aluminium is made into powder, casting time of 1 hour of the process cycle is saved as the molten metal is transferred immediately to the holding furnace, thereby reducing the total heat time to approximately 8 hours only.

In another example, it is observed that 98 Kg of finished product i.e., aluminium and zinc received as output for 100 kg of input of top galvalume dross. In case of using bottom galvalume dross as input, 95 kg of finished product is received. Therefore, the yield is 98% for top galvalume dross and 95% for bottom galvalume dross.

In yet another example, slag, as formed on the molten galvalume dross, contains both metallic and non-metallic content. The slag is put in a steel container and then taken to a shed using a combination of crane and rails. The slag is further processed in a vibro machine which distributes the inner heat of the slag to agglomerate the metallic content together to convert the metallic content into liquid form which is poured out from the vibro machine into a mould to form an ingot. The balance material is allowed to be cooled for few hours and is further passed through Ball Mill and then through a pulverizer to further segregate any metallic content left from the non-metallic content. The metallic content recovered from the slag is then re-melted in the induction furnace and transferred to the Silicon Carbide Crucible furnace for removal of zinc by oxidation and then casting of balance residue aluminium.

### Advantages of the Present Disclosure

The present disclosure provides a method (100) which can enable manufacturers to produce aluminium deox, aluminium powder and zinc oxide from the galvalume dross that is a waste by-product of process of galvanizing metal article in a single batch process. Thus, the method (100) eliminates the requirement of using two independent processes, two different batches and two different raw materials for producing aluminium deox/powder and zinc oxide.

Also, the method (100) aids in bifurcating the galvalume dross into secondary aluminium and zinc independently in a single batch process. The method (100) thus forms a new application for galvalume dross. The method (100) also enables the manufacturer to recycle the galvalume dross in the most efficient and environment friendly manner. Also, use of galvalume dross incurs substantially lower cost as compared to the cost of raw materials used in the independent manufacturing processes to make aluminium deox, aluminium powder and zinc oxide.

The method (100) enables the raw material cost to be substantially lower as compared the competitor manufacturers thus in turn provides a major cost advantage to the manufacturer. Thus the manufacturer can sell secondary aluminium and zinc at lower prices than the other producers.

The method (100) further requires only one set of machinery to produce both secondary aluminium and zinc oxide. Therefore, the present invention saves cost, time, fuel, energy, ground space and manual effort as compared to the traditional methods of producing secondary aluminium and zinc.

In the detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of recovering aluminum and zinc from galvalume dross in a single batch process, the method comprising:
feeding galvalume dross into an induction furnace to melt the galvalume dross, wherein the galvalume dross is received as a by-product;
transferring the molten galvalume dross into a Silicon Carbide Crucible furnace for heating the molten galvalume dross to a predefined temperature, wherein upon heating the molten galvalume dross, zinc vapor evaporates from top of the molten galvalume dross;
collecting the zinc vapor into an oxidation chamber to produce zinc oxide powder;
adding pure aluminum to residual molten metal upon determination of quality testing of the molten metal, wherein the residual molten metal is residual content upon having the zinc vapor evaporated from the molten galvalume dross; and
casting the molten metal by casting machine to produce aluminum deox or aluminum powder.

2. The method as claimed in claim 1, wherein the received galvalume dross is categorized into one of top grade galvalume dross, bottom grade galvalume dross and galvalume dross of defined sizes, wherein the top grade galvalume dross and the bottom grade galvalume dross are categorized based on iron content of the received galvalume dross.

3. The method as claimed in claim 1, wherein top grade galvalume dross is directly fed into the induction furnace for melting and in case of bottom grade galvalume dross, the bottom grade galvalume dross is cut into smaller pieces having dimensions of each piece less than equal to 21 inches, wherein such small pieces of the bottom grade galvalume dross are directly transferred to the Silicon Carbide Crucible furnace for processing.

4. The method as claimed in claim 1, wherein melting the received galvalume dross comprises the steps of:
adding flux additives in a mixture of Cover Flux and Sodium Cryolite to the molten galvalume dross, wherein top of the molten galvalume dross is covered with flux to minimize oxidation level;
removing slag from the top of the molten galvalume dross.

5. The method as claimed in claim 1, wherein transferring the molten galvalume dross into the Silicon Carbide Crucible Furnace comprises the steps of:
tilting the induction furnace by 90 degree, wherein the molten galvalume dross flows through a launder and is filled into a Ladle; and
transferring the molten galvalume dross from the Ladle into the Silicon Carbide Crucible furnace.

6. The method as claimed in claim 1, wherein the molten galvalume dross is heated up to the predefined temperature range of 1300° C. to 1400° C. to boil metal of the molten galvalume dross.

7. The method as claimed in claim 1, wherein collecting the zinc vapor in the oxidation chamber comprises the steps of:
conveying zinc oxide, as produced due to oxidation of the zinc vapor, via a 400 feet long pipe to cool down to form fine white solid Zinc Oxide powder;
collecting the Zinc Oxide powder in a pulsejet air bag house;
determining quality of the Zinc Oxide powder based on predefined standards; and
passing the Zinc Oxide powder through a blender for raising bulk density of the Zinc Oxide powder.

8. The method as claimed in claim 1, wherein adding pure aluminum to the residual molten metal comprises the steps of:
adding flux additives to the residual molten metal;
removing slag from the top of the residual molten metal;
evaluating chemical composition of sample of the slag free residual molten metal by performing quality testing of sample of the slag free residual molten metal and
adding pure aluminium to the residual molten metal based on the evaluation of the chemical composition to achieve desired composition of the residual molten metal.

9. The method as claimed in claim 1, wherein the residual molten metal is casted into moulds of desired shape to obtain the aluminum deox of desired shape.

10. The method as claimed in claim 1, wherein producing aluminium powder from the molten metal comprises the steps of:
transferring the molten aluminium into a Holding Furnace;
atomizing the molten aluminium to form fine aluminum shots by using a jet of high-pressure air;
collecting the fine aluminium shots in a collection chamber attached to the Holding Furnace; and
sieving the fine aluminum shots into varied sizes.
